(19) United States
(12) Patent Application Publication
(10) Pub. No.: US 2009/0106764 A1
(43) Pub. Date: Apr. 23, 2009

(54) Support for globalization in test automation

(75) Inventors: Dmitri Klementiev, Redmond, WA (US); John Budig, Duvall, WA (US); Edward C. Sproull, Bellevue, WA (US); Paul Trieu, Kirkland, WA (US); Ross Wolf, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/975,764

(22) Filed: Oct. 22, 2007

(51) Int. Cl. G06F 9/50

(52) U.S. Cl. 718/104

(57) ABSTRACT

Various technologies and techniques are disclosed for supporting globalization in user interface automation. A resource key is provided that contains at least three data elements. A resource type data element contains data representing a resource type, a resource location data element contains data representing a location to a resource file, and a resource identifier data element contains data-representing a resource identifier. During a resource file extraction operation, the resource location data element is used to locate the resource file, and the resource type data element and the resource identifier data element are used to locate a resource within the resource file that matches the resource type and the resource identifier. A process is provided for resolving a full path name to a resource file. A process is provided for performing a post-extraction action on an extracted resource string.

### BACKGROUND

In the world of software development, it is common for software companies to sell their products in multiple countries that span multiple languages. A different compiled version of the software can be created for each distinct language or culture, but this is inefficient because multiple versions of the same software have to be maintained. These inefficiencies in maintaining multiple versions of the same software led to the development of software globalization and localization techniques. Using globalization techniques, a software program can be developed in a language-neutral and culturally-neutral way so that it is usable across multiple languages and cultures. The aspects of a software program that are specific to a given language or culture are extracted out of the main program and included in resource files. For example, the text that corresponds to the menu items can be contained in the resource files as opposed to being compiled within the main software program. Then, when loading the software for a specific region or language, the resource file(s) containing the specific details for that region or language are loaded along with the rest of the application. This process of loading the software for a specific region or language is called localization.

After creating a software program that is localized to support one or more particular language(s) or region(s), tests need to be performed to ensure that the localized software program operates correctly. In fact, testing needs to be performed on any type of software program, whether it is localized or not. Automated testing programs have been created that allow for tests to be run by a computer without requiring human interaction throughout the test. These automated testing programs allow test scripts to be specified and then executed at selected times. With software programs that have been localized to enable support for multiple languages and regions, it becomes challenging to automate the testing of the software program. A common way of providing automated testing for software that has been globalized is to create a separate test script for each localized version of the software program, thereby resulting in a duplication of testing effort.

### SUMMARY

Various technologies and techniques are disclosed for supporting globalization in user interface automation. A resource key is provided that contains at least three data elements. A resource type data element contains data representing a resource type, a resource location data element contains data representing a location to a resource file, and a resource identifier data element contains data representing a resource identifier. During a resource file extraction operation, the resource file data element is used to locate the resource file, and the resource type data element and the resource identifier data element are used to locate a resource within the resource file that matches the resource type and the resource identifier.

In one implementation, a process is provided for resolving a full path name to a resource file. A determination is made that a resource file is needed for an extraction operation. A key signature contained in a resource key is accessed. If the key signature contains enough information to indicate a first location to search for the resource file, then the first location is searched for the resource file, and if the resource file is found in the first location, then the resource file found in the first location is used for the extraction operation.

However, if the key signature does not contain enough information to indicate the first location, or if the resource file is not found in the first location after searching, then a resource file location value contained in the resource key is accessed to determine a second location to search for the resource file. The second location is searched for the resource file. If the resource file is found in the second location, then the resource file found in the second location is used for the extraction operation.

In another implementation, a process is provided for performing a post-extraction action on an extracted resource string. A resource string that was extracted from a resource file during an extraction action is received. A resource key associated with the resource string is accessed. One or more modifications described in the resource key that need to be made to the resource string are identified. The one or more modifications are performed to the resource string.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an exemplary resource key of one implementation.

FIG. 3 is a diagrammatic view of exemplary resource key types of one implementation.

FIG. 4 is a process flow diagram for one implementation illustrating the high level stages involved in using a resource key with a resource file extraction operation.

FIGS. 5A-5B are process flow diagrams for one implementation illustrating the stages involved in resolving a full path name to a resource file.

FIG. 6 is a process flow diagram for one implementation illustrating the stages involved in performing a post-extraction action on a resource string.

### DETAILED DESCRIPTION

The technologies and techniques herein may be described in the general context as an application that facilitates globalization of automated test scripts, but the technologies and techniques also serve other purposes in addition to these. In one implementation, one or more of the techniques described herein can be implemented as features within an automated testing program, or from any other type of program or service that interacts with resource files containing localized specific information.

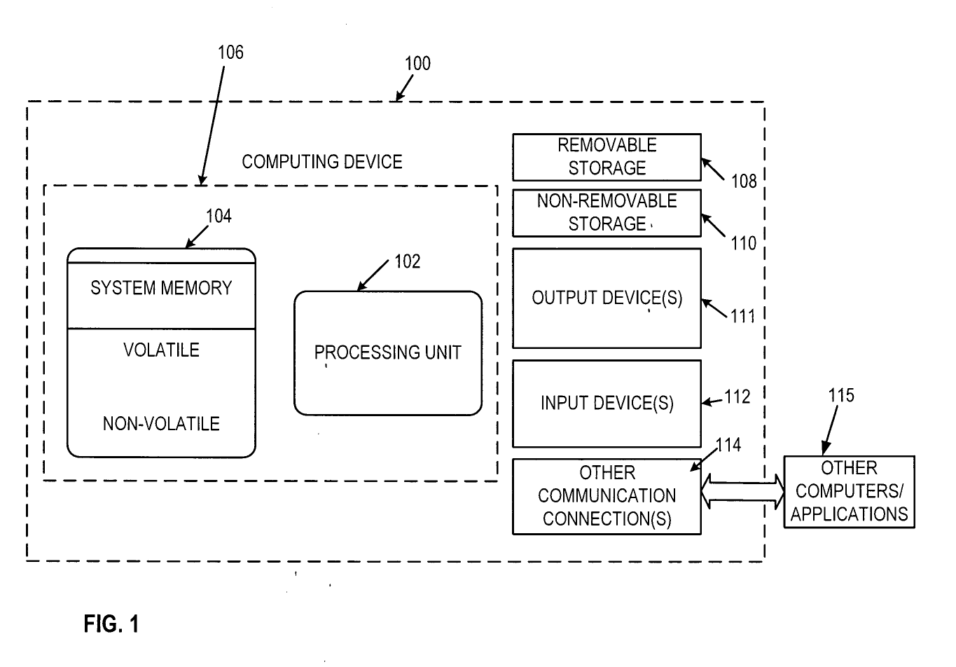

In one implementation, the technologies and techniques described herein provide a way for supporting globalization of test scripts. The term “globalization” as used herein means a manner of providing neutrality that enables support for multiple languages or cultures. The term “globalization of test scripts” means a manner of providing neutrality that allows the same test script(s) to be used across multiple localized versions of a given software application. When the term globalization is used throughout the rest of this specification in a shorthand fashion, the term is referring to globalization of one or more test scripts. By globalizing test scripts, multiple versions of test scripts do not have to be created for each different localization. The term “test script” as used herein is meant to include a script or another means of specifying automation data that is used to test the functionality of a software program in an automated fashion. The technologies and techniques that enable support for globalization of test scripts will be described in further detail in FIGS. 1-6.

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here.

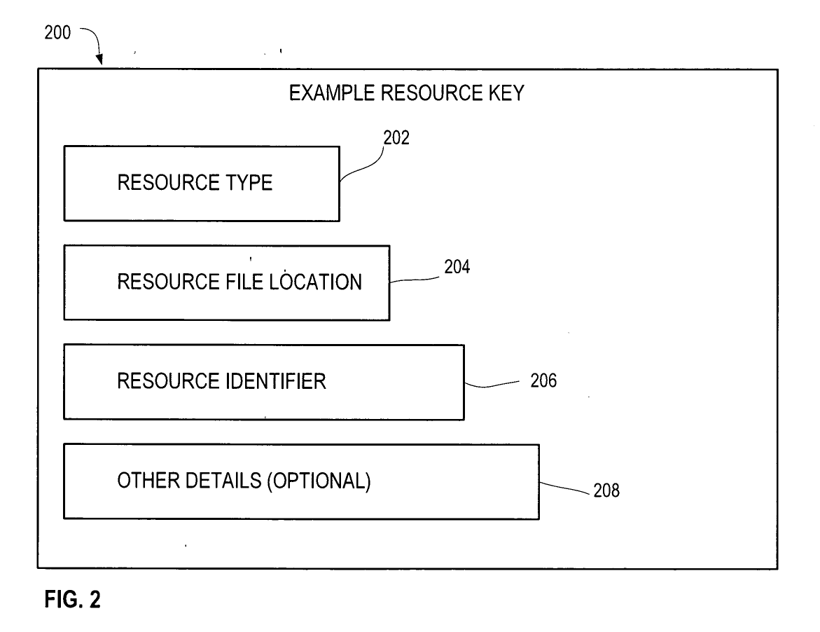

Turning now to FIGS. 2-6, the technologies and techniques involved in providing globalization for test scripts will be explained in further detail. Beginning with FIG. 2, a diagrammatic view 200 of an exemplary resource key of one implementation is illustrated. The term “resource” as used herein is meant to include language-specific, culture-specific, and/or other elements of a software program that support the software program but are not executable code. The term “resource key” as used herein is meant to include a combination of resource information that is used to identify and locate a particular resource within a resource file. A “resource file” is a file or other data structure that contains language-specific, culture-specific, and/or other resource-specific data in a location separate from the code.

In the diagram 200 shown, an example resource key is shown that contains at least three data elements. The resource key can be stored in a text file, in a database, or any other suitable storage structure, and then later accessed by an automated test program to test the functionality of the specific software program. The first data element shown for the resource key is a resource type 202, the second data element shown is a resource file location 204, and the third data element shown is a resource identifier 206. The terms first, second, and third are simply meant for sake of illustration, and other orderings of the information in the resource key could also be used. Other details 208 can optionally be included in the resource key in addition to the other three data elements. The resource type 202 is used to store details about a type of resource being represented, such as a dialog, dialog caption, message, string, and so on. The resource file location 204 represents a location to a resource file. In one implementation, the resource file location 204 represents a relative path to the resource file that is relative to some other path location, such as the current directory. In another implementation, the resource file location 204 represents an absolute path to the resource file that gives an entire path needed to locate the resource file.

The resource identifier 206 represents one or more values that are used to identify a given resource. In one implementation, the resource identifier 206 is a unique identifier for the resource that is unique across all languages and localizations. By using a unique identifier for the resource identifier 206, the proper resources can be located in their respective resource files directly, regardless of the language/localization to which they are directed. In other words, if a unique resource identifier is used, less information can be stored within the resource key in order to facilitate the later location of the proper resource. During a resource file extraction operation, the resource file location is used to locate the resource file. The resource type and the resource identifier are then used to locate a corresponding resource within the resource file that matches that resource type and the resource identifier. In one implementation, a test script requires a specific resource, and an extraction operation is performed at run-time to retrieve the resource and properly globalize the automation to access the additional details that need to be tested for the program.

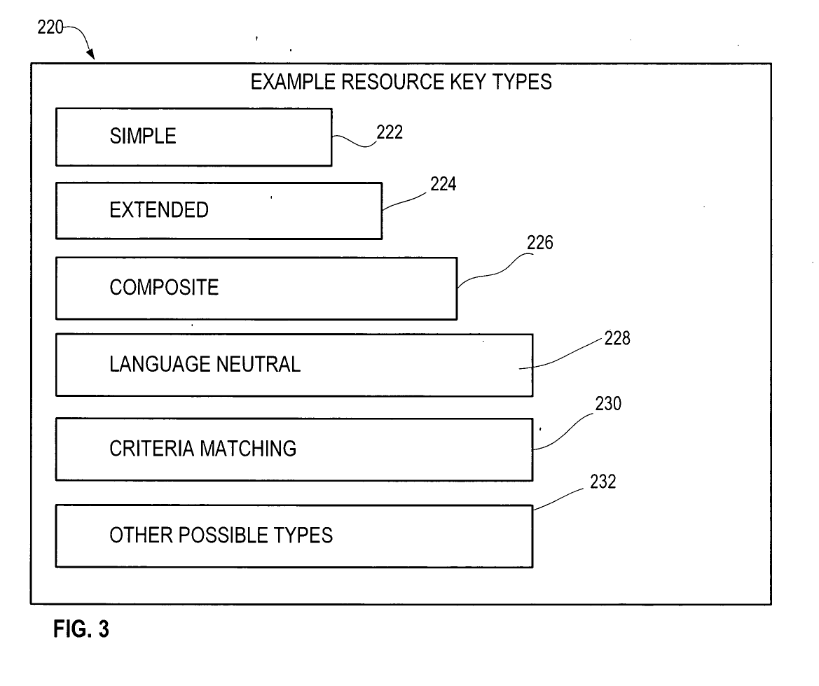

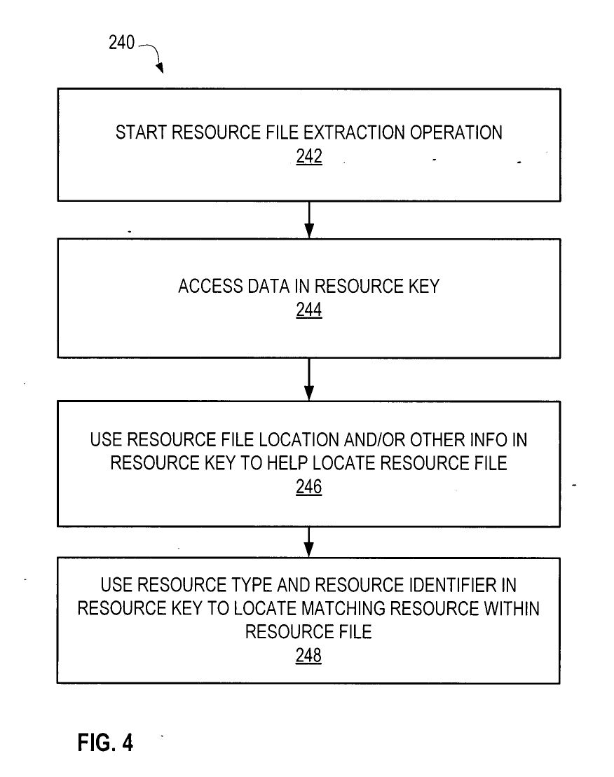

Turning now to FIG. 3, with continued reference to FIG. 2, a diagrammatic view 220 of some exemplary resource key types are shown. In one implementation, some or all of the resource key types shown in FIG. 3 contain at least the three data elements described in FIG. 2: the resource type 202, resource file location 204, and the resource identifier 206. Some of the resource key types can include data elements instead of or in addition to these three previously described. The resource key types shown include: simple resource key 222, extended resource key 224, composite resource key 226, language neutral resource key 228, criteria matching resource key 230, and/or other possible resource key 232. Each of these resource key types will now be looked at in further detail, and then examples will be provided in later figures (FIGS. 4-6) on how these resource keys can be used to support globalization for test scripts.

A simple resource key 222 contains minimal information necessary to extract the string that corresponds to this key. An example of a simple resource key 222 is shown below:

<Friendly String><Resource Type><Resource File><Resource
Identifier><More Identifiers as necessary>

In the above example, the friendly string contains a user friendly name for referring to the string. The resource type, resource file, and resource identifier were described in detail in FIG. 2 (202, 204, and 206, respectively). Delimiters can be used to separate each data element contained in the resource key for the simple resource key 222, and/or for the other resource keys (224, 226, 228, 230, and/or 232). In one implementation, the delimiter is a unique symbol that is not encountered in any of the data elements. In another implementation, when the character(s) represented by the delimiter could possibly occur in other data elements, the delimiter may include escape sequencing that is needed to clarify whether a particular delimiter is intended to be a delimiter or as a part of the data set. The delimiter is used to denote the start and/or end of a given data element.

An extended resource key 224 contains a simple key with additional information. An example of an extended resource key 224 is shown below:

RKB1[target process name] Simple Resource Key.

In one implementation, an extended resource key 224 starts with the signature RKB1 (Resource Key Binary Version 1), and whenever the format of extended resource keys is changed, the version is incremented. The letter “B” in the signature means that the resource string is found in or extracted from a binary file. If the resource string is found in or extracted from a data source listing globalizable resources (such as an LCX file), then the signature starts with RKL. The target process name shown in the above example is used to resolve the full path to a file that contains resources. The specific example of an extended resource key 224 described in this paragraph is just for illustration, and numerous other variations could be used in other implementations to provide an extended resource key 224.

A composite resource key 226 combines simple or extended resource keys, such as using a % s syntax or another syntax. The following example shows how a string that corresponds to one resource key (resKeyIsnotrunning) is used as a formatting string for the actual string that is “Magnifier is not running”.

```
  string resKeyMagnifier =
  @“RKB1[utilman];Magnifier;Win32String;$.\utilman.exe;503”;
string resKeyIsnotrunning = @“RKB1[utilman];%s is not
  running;Win32String;$.\umandlg.dll;4”;
/// Composite Resource Keys
CompositeResourceKeyNative cmplxKeyMagnifierisnotrunning = new
  CompositeResourceKeyNative(resKeyIsnotrunning, new string[ ]
  {resKeyMagnifier});
```

As another example, a user can combine any number of strings by providing a formatting string as a parameter for CompositeResourceKeyNative constructor (or other suitable constructor) and embracing it with “{ }”. For example, to concatenate two strings that correspond to langNeutralCodetxt and resKeyDashNotepad (which corresponds to “code.txt—Notepad”), code such as the following could be used:

```
string resKeyDashNotepad = @“RKB1[notepad]; -
Notepad;Win32String;$.\notepad.exe;5”;
/// LanguageNeutral Strings
LanguageNeutralString langNeutralCodetxt = new
LanguageNeutralString(@“code.txt”);
CompositeResourceKeyNative cmplxKeyCodetxtDashNotepad = new
  CompositeResourceKeyNative(@“{%s%s}”, new string[ ]
  {langNeutralCodetxt, resKeyDashNotepad});
```

In one implementation, when a user calls a method such as ExtractResourceString(complexResKey), the resource extractor will automatically extract strings that correspond to resource keys that compose the complex key and combine them using the formatting string.

If a user explicitly needs to extract a string that corresponds to a resource key of any type, then code such as the following can be used:

String actualString=ExtractResourceString(resKey);

Continuing the discussion on example resource key types, a language neutral resource key 228 represents a string that is language neutral, such as a file name of a critical dependency in the operating system. An example of a language neutral resource key 228 is shown below:

LanguageNeutralString langNeutralCodetxt = new
LanguageNeutralString(@”code.txt”);

A criteria matching resource key 230 can be used to cover the situation when a user needs to run a test script against multiple product SKUs or needs to run the tests against different environments. For example, the user may have a retail version of a product and a debug version of a product. In the first case, resources may come from a first DLL, and in the second case, the resources may come from a second DLL. An example of a criteria matching resource key 230 is shown below:

```
CriteriaMatchingResourceKey criteriaMatching = new
  CriteriaMatchingResourceKey(new string[ ] { resKey1, resKey2,
  resKey3 });
```

The criteria matching resource key 230 can work in the following way: the system attempts to extract the string that corresponds to the resKey1, and if this extraction returns an empty string, then the system attempts to extract the string that corresponds to the resKey2, and so on. In other words, the system extracts strings in the order provided by the user in the code. When a non-empty string is extracted, that string is returned and the remaining resKeys are ignored. This allows a single resource key to be used to handle tests for multiple SKUs of the same product (such as the production and debug versions as described previously).

Turning now to FIGS. 4-6, some examples of how resource keys can be used will be described in further detail. In some implementations, the processes of FIG. 4-6 are at least partially implemented in the operating logic of computing device 100.

FIG. 4 is a process flow diagram for one implementation illustrating the high level stages 240 involved in using a resource key with a resource file extraction operation. The term “extraction operation” as used herein is meant to include an operation that extracts resources from resource files and/or other locations for use for a specified purpose, such as for testing an operation of a software program for which the resource is associated. After a resource file extraction operation is started (stage 242), data in a resource key is accessed (stage 244), and the resource file location and/or other information in the resource key is used to help locate the resource file (stage 246). The resource type and resource identifier in the resource key are used to locate the matching resource within the resource file (stage 248). In other words, the resource type and resource identifier allow the system to pick the proper resource from various resources that are listed in the particular resource file.

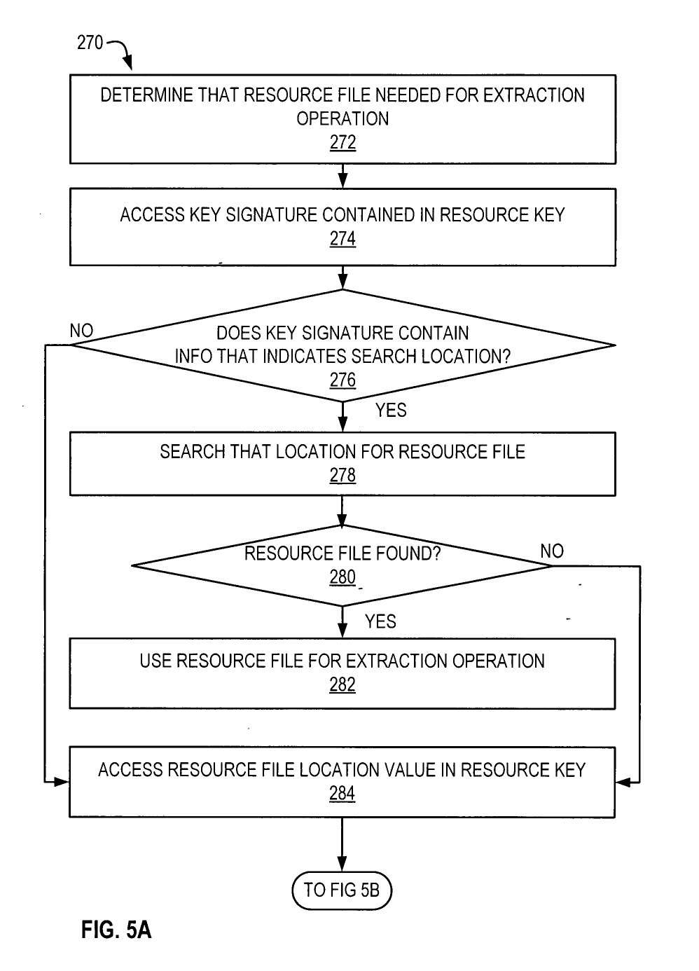

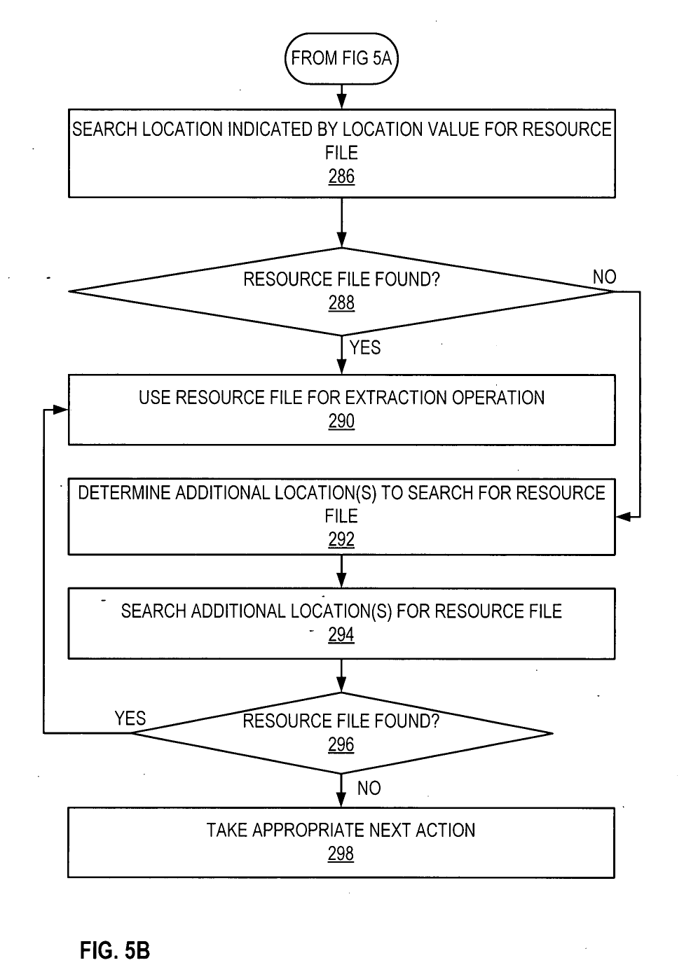

During a resource file extraction operation, there may be times when a full path name needs to be resolved. An example of when this may be necessary includes when only partial path information for the resource file has been provided, as opposed to the absolute path. FIGS. 5A-5B illustrate one implementation of the stages 270 involved in resolving a full path name to a resource file. Upon determining that a resource file is needed for an extraction operation (stage 272), a key signature contained in a resource key is accessed (stage 274). If the key signature contains information that indicates a search location (decision point 276), then that location is searched for the resource file (stage 278). If the resource file was found (decision point 280), then the resource file is used for an extraction operation (stage 282).

If the resource file is not found (decision point 280), or if the key signature did not contain information that indicated the search location (decision point 276), then a resource file location data element is accessed in the resource key (stage 284). The location indicated by the location data element is searched to see if the resource file exists in that location (stage 286). If the resource file was found in that location (decision point 288), then that resource file is used for the extraction operation (stage 290). If the resource file was not found in that location (decision point 288), then additional location(s) to search for resource files are determined (stage 292). Those additional locations are searched for the resource file (stage 294). If the resource file was found in the additional location(s) (decision point 296), then that resource file is used for the extraction operation (stage 290). If the resource file was not found in the additional location(s) (decision point 296), then the appropriate next action is taken (stage 298), such as to skip the testing of that operation, to report an error, and so on.

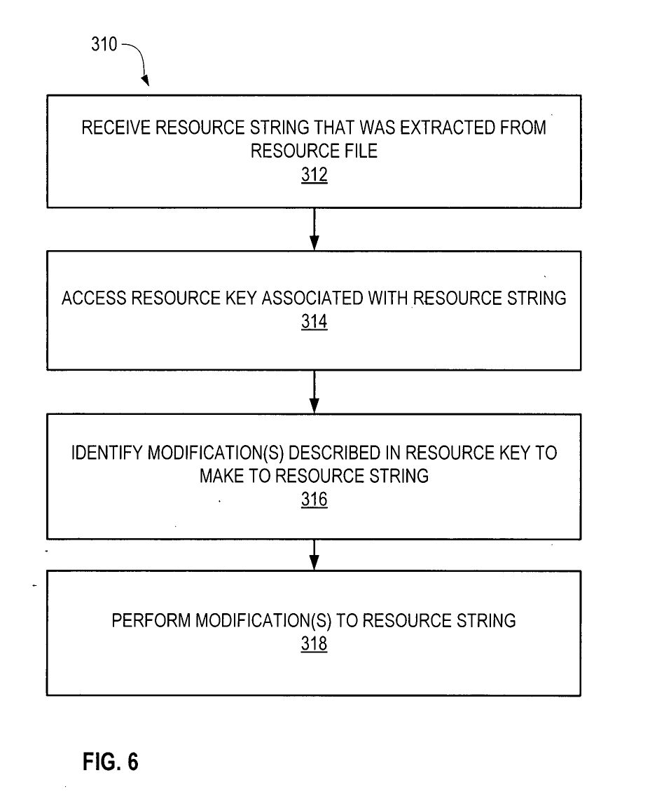

Turning now to FIG. 6, one implementation of the stages 310 involved in performing a post-extraction action on a resource string is illustrated. A post-extraction action is used when an extracted resource string has to be modified after extraction. A resource string is received that was extracted from a resource file (stage 312). A resource key is accessed that was associated with the resource string (stage 314) The modification(s) described in the resource key that need made to the resource string are identified (stage 316). In other words, the resource key is read to determine what additional modifications need to be made to the extracted string. The modification(s) are then performed on the resource string (stage 318).

Some non-limiting examples will now be provided to further illustrate this post-extraction action process. In the first example provided below, a post extraction action is a part of a resource key that appears in angle brackets. For instance, to trim ‘\0’, a format such as the following can be used:

RKB2<TRIMEND(‘\0’)>[wordpad]; Wordpad; Win32String; wordpad.exe; 128”)

As another example, to split the located string into components and get the second components a format such as the following can be used (where ‘\n’ is used as a delimiter):

RKB2<SPLIT(‘\n’, 2)>[wordpad]; Wordpad; Win32 String; wordpad.exe; 128”)

The above resource key reads as (from right to left): use this simple resource key (; Wordpad; Win32String; wordpad.exe; 128) and process name [wordpad] to locate the resource file, extract the string and then apply rules contained in the <SPLIT(‘\n’, 2)> part of the resKey to this string.

As another example, the resource can be combined with another data source (e.g. “Copy % d files . . . ” becomes “Copy 252 files . . . ”). Yet another example can include modifying the string by interpreting the string as the target system would do (e.g. “Save &As . . . ” becomes “Save As . . . ”).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having a data structure stored thereon comprising:
a resource type data element containing data representing a resource type;
a resource location data element containing data representing a location to a resource file;
a resource identifier data element containing data representing a resource identifier; and
wherein during a resource file extraction operation, the resource location data element is used to locate the resource file, and the resource type data element and the resource identifier data element are used to locate a resource within the resource file that matches the resource type and the resource identifier.

2. The computer-readable medium of claim 1, wherein the resource type data element, the resource location data element, and the resource identifier data element are stored in a text file.

3. The computer-readable medium of claim 1, wherein the resource type data element, the resource location data element, and the resource identifier data element are stored in a database.

4. The computer-readable medium of claim 1, wherein the resource file extraction operation is performed during a globalization operation.

5. The computer-readable medium of claim 1, wherein resource location data element represents a relative path to the resource file.

6. The computer-readable medium of claim 1, wherein the resource location data element represents an absolute path to the resource file.

7. The computer-readable medium of claim 1, wherein the resource type data element, the resource location data element, and the resource identifier data element form a resource key.

8. The computer-readable medium of claim 7, wherein a format of the resource key is selected from the group consisting of a simple resource key, an extended resource key, a composite resource key, a language neutral resource key, and a criteria matching resource key.

9. The computer-readable medium of claim 1, wherein the resource identifier data element is a unique identifier for the resource.

10. A method for resolving a full path name to a resource file comprising the steps of:
determining that a resource file is needed for an extraction operation;
accessing a key signature contained in a resource key;
if the key signature contains enough information to indicate a first location to search for the resource file, then:
searching the first location for the resource file; and
if the resource file is found in the first location, then using the resource file found in the first location for the extraction operation;
if the key signature does not contain enough information to indicate the first location, or if the resource file is not found in the first location after searching, then accessing a resource file location value contained in the resource key to determine a second location to search for the resource file;
searching the second location for the resource file; and
if the resource file is found in the second location, then using the resource file found in the second location for the extraction operation.

11. The method of claim 10, further comprising the step of:
if the resource file is not found in the second location, then determining a third location to search for the resource file.

12. The method of claim 11, wherein the third location to search is based upon one or more paths referenced in an environment variable.

13. The method of claim 11, wherein the third location to search is a common repository of resource files.

14. The method of claim 11, further comprising the steps of:
searching the third location for the resource file; and
if the resource file is found in the third location, then using the resource file found in the third location for the extraction operation.

15. The method of claim 10, wherein the resource file location value contains a relative path to a supporting program file that corresponds to the target application.

16. The method of claim 10, wherein the key signature contains one or more delimiters that provide suggestions about the first location.

17. A computer-readable medium having computer-executable instructions for causing a computer to perform the steps recited in claim 10.

18. A method for performing a post-extraction action on an extracted resource string comprising the steps of:
receiving a resource string that was extracted from a resource file during an extraction action;
accessing a resource key associated with the resource string;
identifying one or more modifications described in the resource key that need to be made to the resource string; and
performing the one or more modifications to the resource string.

19. The method of claim 18, wherein the resource key was also used during the extraction action to aid in an extraction of the resource string.

20. A computer-readable medium having computer-executable instructions for causing a computer to perform the steps recited in claim 18.
